(19) United States
(12) Patent Application Publication
(10) Pub. No.: US 2026/0054669 A1
(43) Pub. Date: Feb. 26, 2026

(54) AUTO REPLY DEVICE, AUTO REPLY METHOD, AND COMPUTER PROGRAM FOR AUTO REPLY

(71) Applicant: TOYOTA JIDOSHA KABUSHIKI KAISHA, Toyota-shi (JP)

(72) Inventor: Yuta TSUZUKI, Tokyo-to (JP)

(73) Assignee: TOYOTA JIDOSHA KABUSHIKI KAISHA, Toyota-shi (JP)

(21) Appl. No.: 19/248,990

(22) Filed: Jun. 25, 2025

(30) Foreign Application Priority Data
Aug. 22, 2024 (JP) 2024-141089

(51) Int. Cl. B60R 16/037; G10L 15/22

(52) U.S. Cl. CPC B60R 16/0373; G10L 15/22; G10L 2015/227; G10L 2015/228

(57) ABSTRACT

An auto reply device includes a processor configured to estimate a position of a speaking occupant among a plurality of occupants of a vehicle, and generate reply information to an utterance of the speaking occupant by inputting position information indicating the position of the speaking occupant and voice information representing the utterance into a generation model that is pre-trained to generate the reply information.

### FIELD

The present invention relates to an auto reply device that automatically replies to an utterance of an occupant of a vehicle, an auto reply method, and a computer program for auto reply.

### BACKGROUND

A proposed voice recognition control system recognizes an utterance and the position where the utterance is given, based on a voice of an occupant of a vehicle, and selects and outputs some of pieces of information on a facility indicated by a gesture of a person at the recognized position, based on the recognized utterance and position; the gesture is detected based on an image of the vehicle interior (see Japanese Unexamined Patent Publication No. 2017-90615).

### SUMMARY

Required replies may vary depending on the position of a speaking occupant.

It is an object of the present invention to provide an auto reply device that can reply to a speaking occupant among a plurality of occupants in a vehicle appropriately.

According to an embodiment, an auto reply device is provided. The auto reply device includes a processor configured to: estimate a position of a speaking occupant among a plurality of occupants of a vehicle, and generate reply information to an utterance of the speaking occupant by inputting position information indicating the position of the speaking occupant and voice information representing the utterance into a generation model that is pre-trained to generate the reply information.

In an embodiment, the processor is further configured to control a device provided at the position of the speaking occupant, based on the reply information.

In an embodiment, the processor is further configured to identify a sub-region corresponding to the position of the occupant indicated by the position information in an interior image representing the interior of the vehicle. The processor generates the reply information by further inputting the sub-region into the generation model.

According to another embodiment, an auto reply method is provided. The auto reply method includes estimating a position of a speaking occupant among a plurality of occupants of a vehicle, and generating reply information to an utterance of the speaking occupant by inputting position information indicating the position of the speaking occupant and voice information representing the utterance into a generation model that is pre-trained to generate the reply information.

According to still another embodiment, a non-transitory recording medium that stores a computer program for auto reply is provided. The computer program includes instructions causing a computer to execute a process including estimating a position of a speaking occupant among a plurality of occupants of a vehicle, and generating reply information to an utterance of the speaking occupant by inputting position information indicating the position of the speaking occupant and voice information representing the utterance into a generation model that is pre-trained to generate the reply information.

The auto reply device of the present disclosure has an advantageous effect of being able to reply to a speaking occupant among a plurality of occupants in a vehicle appropriately.

### BRIEF DESCRIPTION OF DRAWINGS

FIG. 1 schematically illustrates the configuration of a vehicle equipped with an auto reply device.

FIG. 2 illustrates the hardware configuration of the auto reply device.

FIG. 3 is a functional block diagram of a processor of the auto reply device.

FIG. 4 illustrates the relationship between input into a generation model and reply information according to the embodiment.

FIG. 5 is an operation flowchart of the auto reply device.

### DESCRIPTION OF EMBODIMENTS

An auto reply device as well as an auto reply method and a computer program for auto reply executed by the auto reply device will now be described with reference to the attached drawings. The auto reply device estimates the position of a speaking occupant among a plurality of occupants of a vehicle. The auto reply device then generates reply information to an utterance of the speaking occupant by inputting position information indicating the position of the speaking occupant and voice information representing the utterance into a generation model that is pre-trained to generate the reply information.

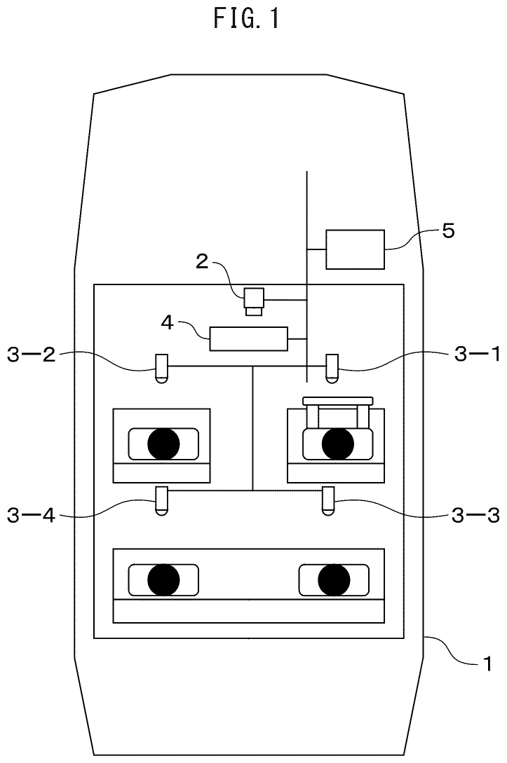

FIG. 1 schematically illustrates the configuration of a vehicle equipped with an auto reply device. In the present embodiment, the vehicle 1 includes a camera 2, multiple microphones 3-1 to 3-n (n is an integer of 2 or more and is four in the illustrated example), a notification device 4, and an auto reply device 5. The camera 2, the microphones 3-1 to 3-n, and the notification device 4 are communicably connected to the auto reply device 5.

The camera 2, which is an example of an interior imaging unit, is installed near the top of the windshield and oriented to the vehicle interior so that all the occupants in the vehicle 1 are included in the region to be captured by the camera. Every predetermined capturing period, the camera 2 generates an image representing the interior of the vehicle 1 and outputs the generated image to the auto reply device 5. An image generated by the camera 2 will be referred to as an “interior image,”below.

The microphones 3-1 to 3-n pick up a voice of an occupant in the vehicle 1 and outputs a voice signal representing the voice. To achieve this, for each seat of the vehicle 1, one of the microphones 3-1 to 3-n is installed at a position where a voice of an occupant sitting on the seat can be picked up. In the example illustrated in FIG. 1, the microphones are installed near the driver's seat, the passenger seat, the right rear seat, and the left rear seat, respectively (for example, those of the driver's seat and the passenger seat are on an instrument panel, and those of the rear seats are on the backs of the front seats). The microphones 3-1 to 3-n may be arrayed at positions where a voice of any occupant in the vehicle interior can be picked up (e.g., near the ceiling of the front of the vehicle interior or on the instrument panel). The microphones 3-1 to 3-n each output a generated voice signal to the auto reply device 5.

The notification device 4 is provided in the interior of the vehicle 1 and notifies an occupant of a reply represented by reply information generated by the auto reply device 5. To achieve this, the notification device 4 includes, for example, at least one of a speaker or a display. When a notification signal representing a reply to an occupant is received from the auto reply device 5, the notification device 4 notifies the occupant of the reply by a voice from the speaker or by displaying a message, an image, or a video on the display. For each seat, a display or a speaker included in the notification device 4 may be installed and oriented to an occupant sitting on the seat. In this case, the display or speaker provided for a seat where a speaking occupant is sitting may display a reply or output a voice representing a reply.

The auto reply device 5 generates reply information to an utterance of an occupant of the vehicle 1, and notifies the generated reply information to the occupant of the vehicle 1 via the notification device 4 or controls a device of the vehicle 1 according to the reply information.

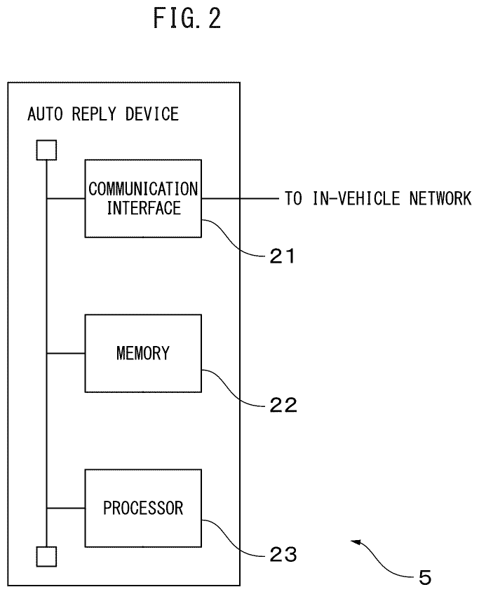

FIG. 2 illustrates the hardware configuration of the auto reply device 5. As illustrated in FIG. 2, the auto reply device 5 includes a communication interface 21, a memory 22, and a processor 23. The communication interface 21, the memory 22, and the processor 23 may be configured as separate circuits or a single integrated circuit.

The communication interface 21 includes an interface circuit for connecting the auto reply device 5 to another device inside the vehicle. The communication interface 21 passes an interior image received from the camera 2 and voice signals received from the microphones 3-1 to 3-n to the processor 23. The communication interface 21 outputs a notification signal received from the processor 23 to the notification device 4 or a control command received from the processor 23 to a vehicle-mounted device.

The memory 22, which is an example of a storage unit, includes, for example, volatile and nonvolatile semiconductor memories, and stores various types of data used in an auto reply process executed by the processor 23. More specifically, the memory 22 stores parameters specifying a generation model for generating reply information. In addition, the memory 22 may temporarily store interior images received from the camera 2 and voice signals received from the microphones 3-1 to 3-n.

The processor 23 includes one or more central processing units (CPUs) and a peripheral circuit thereof. The processor 23 may further include another operating circuit, such as a logic-arithmetic unit, an arithmetic unit, or a graphics processing unit. The processor 23 executes an auto reply process.

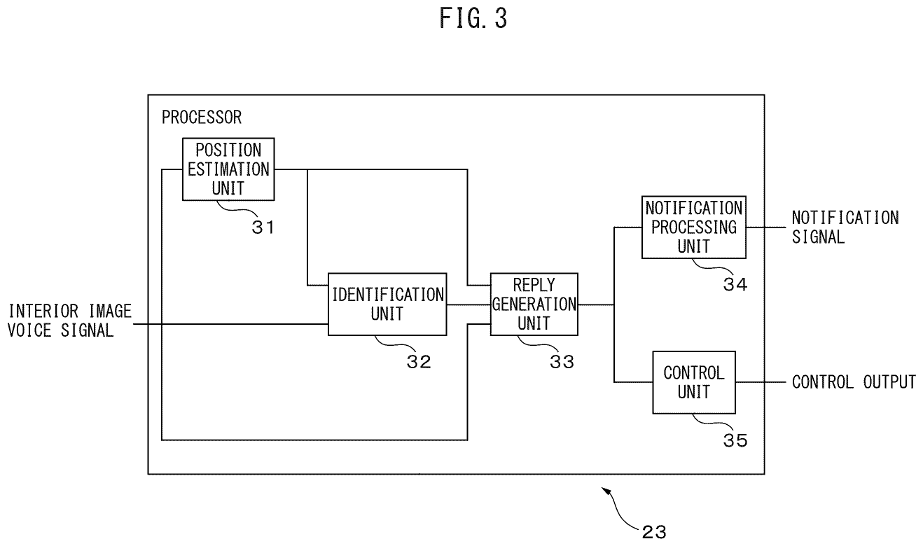

FIG. 3 is a functional block diagram of the processor 23, related to the auto reply process. The processor 23 includes a position estimation unit 31, an identification unit 32, a reply generation unit 33, a notification processing unit 34, and a control unit 35. These units included in the processor 23 are, for example, functional modules implemented by a computer program executed by the processor 23, or may be dedicated operating circuits provided in the processor 23.

The position estimation unit 31 estimates the position of a speaking occupant among a plurality of occupants. In the present embodiment where each seat is provided with a microphone, the position estimation unit 31 assumes that an occupant is speaking in a most recent predetermined period (e.g., several seconds), when the average volume of one of voice signals generated by the microphones 3-1 to 3-n in the predetermined period exceeds an utterance detection threshold. The position estimation unit 31 estimates the position of a seat provided with a microphone whose average volume in the predetermined period is the highest to be the position of the speaking occupant.

In an embodiment where the microphones 3-1 to 3-n are arrayed, the position estimation unit 31 also assumes that an occupant is speaking in a most recent predetermined period, when the average volume of one of voice signals generated by the microphones in the predetermined period exceeds the utterance detection threshold. The position estimation unit 31 calculates the phase differences between voice signals from the microphones in the predetermined period, and estimates the direction from which a voice comes, based on the calculated phase differences. The position estimation unit 31 then estimates that the position of a seat in a direction closest to the direction from which the voice comes as viewed from the installed positions of the microphones 3-1 to 3-n is the position of the speaking occupant. In this case, the directions from the installed positions of the microphones to the respective seats may be pre-stored in the memory 22. The position estimation unit 31 identifies a seat in the direction closest to the direction from which the voice comes of the directions to the respective seats, and estimates the position of the identified seat to be that of the speaking occupant.

Alternatively, the position estimation unit 31 may estimate the position of a speaking occupant, based on interior images. In this case, the position estimation unit 31 inputs interior images in the order of their generation into a classifier that is pre-trained to estimate the position of a speaking occupant. When an occupant is speaking in a most recent predetermined period, the classifier for position estimation outputs the position of the speaking occupant. The classifier for position estimation is configured as a deep neural network (DNN) having a recursive structure, such as a recurrent neural network (RNN) or Long Short-Term Memory (LSTM).

The position estimation unit 31 generates position information indicating an estimation of the position of the speaking occupant, and outputs the generated position information to the identification unit 32 and the reply generation unit 33. The position information includes a character string representing the position of the speaking occupant (e.g., a character string representing the seat of the speaking occupant, such as “driver's seat” or “passenger seat”) or a vector indicating the position of the speaking occupant. When the position of the speaking occupant is indicated by a vector, the vector is generated, for example, so that different elements are included for the respective seats and that the value of an element corresponding to the seat where the speaking occupant is sitting differs from the values of elements corresponding to the other seats.

The identification unit 32 identifies a sub-region corresponding to the position of the speaking occupant indicated by the position information in an interior image. For example, for each seat, the position and area in an interior image that are set so as to include an occupant sitting on the seat is pre-stored in the memory 22. The identification unit 32 reads the position and area of the seat corresponding to the position of the speaking occupant indicated by the position information from the memory 22, and identifies a region specified by the read position and area as a sub-region corresponding to the position of the speaking occupant.

Alternatively, the identification unit 32 may detect regions representing individual occupants in an interior image by inputting the interior image into a classifier that is pre-trained to detect an occupant. Of the regions representing individual occupants, the identification unit 32 identifies a region corresponding to the position of the speaking occupant indicated by the position information as a sub-region corresponding to the position of the speaking occupant. In this case, for each seat, the position of a reference point corresponding to the seat in an interior image is pre-stored in the memory 22. Of the regions representing individual occupants, the identification unit 32 identifies a region closest to the reference point of the seat corresponding to the position of the speaking occupant indicated by the position information as a sub-region corresponding to the position of the speaking occupant. The classifier for occupant detection is configured as a DNN having architecture of a convolutional neural network (CNN) type, such as Single Shot MultiBox Detector, or a DNN having an attention mechanism, such as Vision transformer. Alternatively, the classifier for occupant detection may be configured as a classifier based on a machine learning technique other than a DNN, such as an AdaBoost classifier.

The identification unit 32 notifies the reply generation unit 33 of the position and area of the sub-region representing the speaking occupant.

The reply generation unit 33 generates reply information to an utterance of the speaking occupant by inputting position information indicating the position of the speaking occupant, voice information representing the utterance, and the sub-region representing the speaking occupant into a generation model that is pre-trained to generate the reply information.

To generate voice information representing an utterance, the reply generation unit 33 inputs a voice signal whose average volume in a most recent predetermined period exceeds the utterance detection threshold among voice signals generated by the microphones 3-1 to 3-n into a voice recognition model, thereby recognizing an utterance represented by the voice signal, and generates a character string representing the utterance as voice information. Such a voice recognition model is configured, for example, as a DNN having an attention mechanism or a DNN having a recursive structure, such as a RNN or LSTM. Alternatively, the voice recognition model may be configured as a GMM-HMM based on a mixture Gaussian distribution and a hidden Markov model or as a DNN-HMM based on a DNN and a hidden Markov model. The reply generation unit 33 may divide a voice signal into frames each having a predetermined length of time, extract a feature of the voice for each frame, and input the feature of each frame into the voice recognition model in chronological order, thereby recognizing an utterance represented by the voice signal. The feature of each frame may be, for example, a predetermined element of the cepstrum of the frame.

The reply generation unit 33 adds the character string representing the position of the speaking occupant in the position information to the beginning or end of the character string representing the utterance in the voice information, thereby representing a combination of the utterance and the position of the speaking occupant with a single character string.

To input the sub-region representing the speaking occupant into the generation model, the reply generation unit 33 crops the sub-region indicated by the position and area notified by the identification unit 32 from an interior image. Alternatively, the reply generation unit 33 may rewrite the values of pixels in an interior image other than the sub-region indicated by the position and area notified by the identification unit 32 with a predetermined value to mask the image except the sub-region.

In the present embodiment, the generation model is configured as a vision language model (VLM). The VLM that is the generation model is configured, for example, as a combination of an image encoder that encodes an inputted image and a large language model (LLM) with multiple stacked blocks each including an attention layer and a feed forward layer. The reply generation unit 33 inputs the cropped sub-region or the interior image masked except the sub-region into the image encoder, and further inputs the character string representing the utterance and the position of the speaking occupant into the LLM. The generation model then outputs text data representing a reply as reply information. Inputting position information, together with voice information representing an utterance, into the generation model in this way enables the generation model to generate reply information representing a reply depending on the position of the speaking occupant. In addition, the use of a sub-region representing the speaking occupant in an interior image as well as voice information and position information for generating reply information enables the generation model to determine the state of the speaking occupant with the interior image. Thus the generation model can generate reply information representing a more appropriate reply to the speaking occupant. For example, when the speaking occupant is an infant even if the utterance is a request for opening a window or a door, the generation model can generate reply information including a soothing reply message, such as “Wait a minute,” without unlocking the window or door. When generating reply information for displaying a video on the display installed at the position of the speaking occupant, the generation model can determine the content of the video to be displayed, taking account of the state of the speaking occupant.

For example, when the speaking occupant is sitting on the rear right seat, a sub-region representing the occupant sitting on the rear right seat is inputted into the generation model. When the utterance is “Hot,” a character string such as “rear right seat, hot” is inputted into the generation model. The generation model then outputs text data such as “The air conditioning of the rear right seat is turned to high”as reply information.

The reply information may include information for controlling the vehicle 1 itself or a device mounted on the vehicle 1.

According to a modified example, the generation model may include an input layer for inputting position information into which a vector indicating the position of a speaking occupant is inputted, separately from the image encoder and the LLM. In this case, only a character string corresponding to voice information is inputted into the LLM, and a vector indicating the position of a speaking occupant is inputted into the input layer for inputting position information. The vector indicating the position of a speaking occupant and inputted into the input layer is taken into the LLM in a block having a cross-attention mechanism that calculates cross attention of the vector and output from an upstream block among the multiple blocks included in the LLM, like a sub-region inputted into the image encoder.

The reply generation unit 33 outputs the generated reply information, together with the position information, to the notification processing unit 34 and the control unit 35.

The notification processing unit 34 outputs the reply information via the notification device 4. To achieve this, the notification processing unit 34 generates a notification signal representing a reply included in the reply information, and outputs the generated notification signal to the notification device 4 via the communication interface 21. For example, based on the text data representing a reply included in the reply information, the notification processing unit 34 generates a voice signal representing the reply as a notification signal in accordance with a predetermined speech synthesis technique. The notification processing unit 34 then outputs the notification signal to the speaker included in the notification device 4, causing the speaker to output a voice representing the reply. Alternatively, the notification processing unit 34 includes the text data representing a reply in the notification signal, and then causes the text data representing a reply to appear on the display included in the notification device 4.

When the notification device 4 includes a display or a speaker for each seat, the notification processing unit 34 outputs a notification signal via the communication interface 21 to the display or speaker provided for the seat indicated by the position information where the speaking occupant is sitting. The notification processing unit 34 then causes the text data representing a reply to appear on the display provided for the seat where the speaking occupant is sitting, or causes the speaker provided for the seat to output a voice representing the reply. In this way, the notification processing unit 34 can reply appropriately even if the reply is aimed only at the speaking occupant.

When the reply information generated by the generation model represents control of a device of the vehicle 1, the processing of the notification processing unit 34 may be omitted.

The control unit 35 controls a device specified by the reply included in the reply information according to the reply. The control unit 35 determines a device to be controlled and a control command by referring to a reference table for control representing the correspondence between text data representing a reply included in reply information, a device to be controlled (including the vehicle 1 itself), and a control command for executing the control. The control unit 35 then outputs the determined control command to an electronic control unit (ECU) of the device to be controlled, via the communication interface 21.

The device to be controlled may be one provided at the position of the speaking occupant. In this case, the control unit 35 identifies the position of the speaking occupant by referring to the position information, and identifies a device to be controlled, based on the text data representing a reply, as described above. The control unit 35 then outputs a control command and a signal indicating the position of the device to be controlled to an ECU of the device, thereby controlling the device provided at the position of the speaking occupant according to the reply information.

For example, assume that the speaking occupant is sitting on the rear right seat, and that reply information indicating that air sent to the rear right seat will be increased by a predetermined amount is generated in response to an utterance “Hot. ” In this case, the control unit 35 outputs a control command for increasing air sent from a vent closest to the rear right seat by a predetermined amount to an ECU that controls an air conditioner.

Besides an air conditioner, devices to be controlled depending on the position of a speaking occupant may include a window, a door lock, an indoor light, or a seat. As control of a device according to a reply, the control unit 35 opens or closes a window closest to the position of a speaking occupant, locks or unlocks a door closest to the position of a speaking occupant, turns on or off an indoor light closest to the position of a speaking occupant, or adjusts the position of a seat where a speaking occupant is sitting.

In the case where a reply represented by reply information relates to travel control of the vehicle 1, the control unit 35 may output a control command indicated by the reply to an ECU that controls travel of the vehicle 1 only when the position of the speaking occupant is the driver's seat, i.e., only when the speaking occupant is the driver.

For example, assume that the utterance is “Faster. ” In this case, only when the position of the speaking occupant indicated by the position information is that of the driver's seat, the control unit 35 outputs a control command for increasing a target speed of the vehicle 1 by a predetermined amount to the ECU that controls travel of the vehicle 1. When the position of the speaking occupant indicated by the position information is that of a seat other than the driver's seat, e.g., the passenger seat, the control unit 35 does not output a control command depending on the reply. This prevents travel of the vehicle 1 from being controlled inadvertently by an occupant other than the driver, which prevents motion of the vehicle 1 from being destabilized. The control unit 35 determines whether the device to be controlled indicated by text data representing a reply is the ECU that controls travel of the vehicle 1, by referring to the reference table for control.

When the text data representing a reply does not include any of words that specify a device to be controlled and that are registered in the reference table for control, the reply information is not aimed at controlling a device. Thus, in this case, the control unit 35 does not output a control signal.

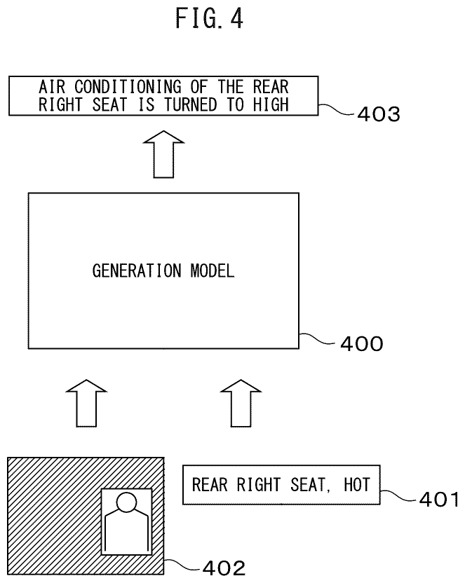

FIG. 4 illustrates the relationship between input into a generation model and reply information according to the present embodiment. In the present embodiment, text data 401 including an utterance (“Hot”) and position information of a speaking occupant (“Rear right seat”) and a sub-region 402 representing the occupant on the rear right seat and extracted from an interior image are inputted into a generation model 400. By referring to the text data 401 and the sub-region 402, the generation model 400 outputs text data 403 representing a reply to the utterance (“Air conditioning of the rear right seat is turned to high”).

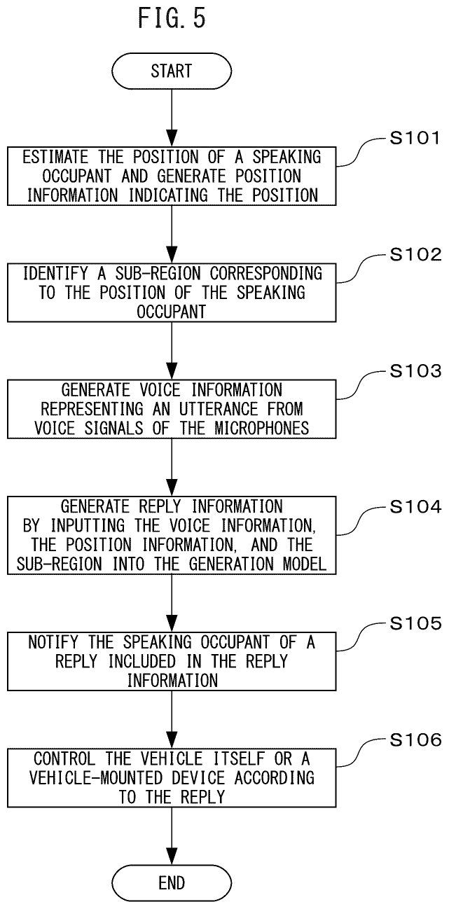

FIG. 5 is an operation flowchart of the auto reply process of the present embodiment. The processor 23 executes the auto reply process in accordance with this operation flowchart.

The position estimation unit 31 estimates the position of a speaking occupant and generates position information indicating the position (step S101). The identification unit 32 identifies a sub-region corresponding to the position of the speaking occupant in an interior image (step S102).

The reply generation unit 33 generates voice information representing the occupant's utterance, based on a voice signal generated by one of the microphones 3-1 to 3-n (step S103). The reply generation unit 33 then generates reply information by inputting the voice information, the position information, and the sub-region corresponding to the position of the speaking occupant into the generation model (step S104).

The notification processing unit 34 notifies all the occupants or the speaking occupant of a reply included in the reply information via the notification device 4 (step S105). The control unit 35 controls the vehicle 1 itself or a device mounted on the vehicle 1, in particular, a device provided at the position of the speaking occupant, according to the reply (step S106).

As has been described above, the auto reply device estimates the position of a speaking occupant among a plurality of occupants of a vehicle. The auto reply device then generates reply information to an utterance of the speaking occupant by inputting position information indicating the position of the speaking occupant and voice information representing the utterance into a generation model that is pre-trained to generate the reply information. The auto reply device can therefore reply to a speaking occupant among a plurality of occupants in a vehicle more appropriately.

According to a modified example, the reply generation unit 33 may generate reply information by inputting position information indicating the position of a speaking occupant and voice information representing an utterance into a generation model, without inputting a sub-region representing the speaking occupant into the generation model. In this case, a LLM is used as the generation model, and the processing of the identification unit 32 may be omitted. In this modified example also, since position information is inputted into the generation model, the auto reply device can reply to the speaking occupant appropriately. Further, in this modified example, since the processing related to interior images is omitted, the amount of computation is smaller than in the above-described embodiment.

In the above-described embodiment or modified examples, a server that is communicable via a vehicle-mounted wireless communication terminal (not illustrated) may include a generation model and execute the processing of the reply generation unit 33 to generate reply information. In this case, the auto reply device 5 generates a query signal including text data representing the position of a speaking occupant and an utterance and a sub-region that represents the speaking occupant and that is cropped from an interior image, and transmits the generated query signal to the server via the wireless communication terminal. The server generates reply information by inputting the text data and the sub-region included in the received query signal into the generation model, and transmits the generated reply information to the wireless communication terminal of the vehicle 1 from which the query signal is transmitted. When no sub-region is inputted into the generation model, the auto reply device 5 need not include a sub-region in the query signal. The auto reply device 5 executes the processing of the notification processing unit 34 and the control unit 35 according to reply information received via the wireless communication terminal. According to this modified example, the auto reply device 5 can use a larger generation model for generating reply information than a generation model achieved by vehicle-mounted hardware resources, and can therefore generate more appropriate reply information.

According to another modified example, the processing of the notification processing unit 34 or the control unit 35 may be omitted.

According to still another modified example, the generation model may be configured so that a voice signal assumed to include an utterance is directly inputted, together with position information, and the generation model may be pre-trained to recognize an utterance from a voice signal and to generate reply information depending on the utterance and the position of the speaking occupant.

The computer program for achieving the auto reply process of the above-described embodiment or modified examples may be provided in a form recorded on a computer-readable portable storage medium.

As described above, those skilled in the art may make various modifications according to embodiments within the scope of the present invention.

What is claimed is:

1. An auto reply device comprising:
a processor configured to:
estimate a position of a speaking occupant among a plurality of occupants of a vehicle, and
generate reply information to an utterance of the speaking occupant by inputting position information indicating the position of the speaking occupant and voice information representing the utterance into a generation model that is pre-trained to generate the reply information.

2. The auto reply device according to claim 1, wherein the processor is further configured to control a device provided at the position of the speaking occupant, based on the reply information.

3. The auto reply device according to claim 1, wherein the processor is further configured to identify a sub-region corresponding to the position of the occupant indicated by the position information in an interior image representing the interior of the vehicle, wherein
the processor generates the reply information by further inputting the sub-region into the generation model.

4. An auto reply method comprising:
estimating a position of a speaking occupant among a plurality of occupants of a vehicle; and
generating reply information to an utterance of the speaking occupant by inputting position information indicating the position of the speaking occupant and voice information representing the utterance into a generation model that is pre-trained to generate the reply information.

5. A non-transitory recording medium that stores a computer program for auto reply, the computer program causing a computer to execute a process comprising:
estimating a position of a speaking occupant among a plurality of occupants of a vehicle; and
generating reply information to an utterance of the speaking occupant by inputting position information indicating the position of the speaking occupant and voice information representing the utterance into a generation model that is pre-trained to generate the reply information.
